(19) United States
(12) Patent Application Publication
(10) Pub. No.: US 2009/0133618 A1
(43) Pub. Date: May 28, 2009

(54) COATING APPARATUS

(75) Inventor: Yasuhito NARUSE, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/281,281

(22) PCT Filed: Feb. 20, 2007
(86) PCT No.: PCT/JP2007/053453

§ 371 Date: Aug. 29, 2008

(30) Foreign Application Priority Data
Mar. 1, 2006 (JP) 2006-055325

(51) Int. Cl. B05C 1/08; B05C 11/02

(52) U.S. Cl. 118/200

(57) ABSTRACT

A coating apparatus is provided which does not form lines having a constant pitch in applying a coating solution to a web or a sheet medium by using a coating rod or a coating roller even at a high speed. The present invention relates to a coating apparatus for applying a coating solution to a continuously running support medium via a coating rod. A coating rod (12C) is a cylindrical body having an outer surface in which convex sections having a width P1 and concave sections having a width P2 are alternately formed in an axial direction of the surface, so that a series of convex and concave sections having a constant pitch P=P1+P2 are formed. Each of the convex sections has a cross section of an angled profile, and has a flat part having a width P3 of 0.55 P or more which is formed between a right end part (R) and a left end part (L) located on opposite ends of the angled profile downward from the top (T) of the angled profile by 3 μm.

### TECHNICAL FIELD

The present invention relates to a coating apparatus, in particular, to a coating apparatus for applying a coating solution to a continuously running support medium via a coating rod.

### BACKGROUND ART

A coating method which uses a coating rod or a coating roller to apply a coating solution to a continuously running support medium (hereinafter, referred to as a web) or a sheet medium is known. In the coating method, an excess amount of a coating solution is once transferred to a web, and then a coating rod or a coating roller which is static or rotating is used to scrape off the excess coating solution to make a desired amount of the coating solution remained. Since the method provides an advantage that a thin coating can be achieved at a high speed by an operation using a simple apparatus, it is widely used.

The applicant of the present invention proposed a novel coating rod which has a groove formed therein as a coating device to be used in the above coating method (see Japanese Patent Application Laid-Open No. 7-31920 and Japanese Patent Application Laid-Open No. 5-347), and the intended effect of the coating rod has been proved. For example, the Japanese Patent Application Laid-Open No. 7-31920 discloses a specification which defines a shape of the groove which is formed in a rod of a coating apparatus. The Japanese Patent Application Laid-Open No. 5-347 discloses a method and an apparatus for manufacturing a coating rod by rolling.

However, the coating method for applying a coating solution to a web or a sheet medium by using a coating rod or a coating roller involves a serious problem that in rotating a coating rod or a coating roller at the same speed (the same peripheral speed) as that of a web or the like to be transported, as the speed is increased, lines having a constant pitch are formed in a direction in which the web or the like is transported, and the manifested lines will cause a critical planar defect.

The apparatuses having various structures, the methods, and the proposals in the prior art have not solved such a planar defect due to the lines yet.

The present invention was made in view of the background, and one object of the present invention is to provide a coating apparatus which does not form lines having a constant pitch even at a high speed in applying a coating solution to a web or a sheet medium by using a coating rod or a coating roller.

### DISCLOSURE OF THE INVENTION

The present invention, in order to achieve the above object, provides a coating apparatus for applying a coating solution to a continuously running support medium via a coating rod, the coating rod being a cylindrical body having an outer surface in which convex sections having a width P1 and concave sections having a width P2 are alternately formed in an axial direction of the surface, so that a series of convex and concave sections having a constant pitch P=P1+P2 are formed, and each of the convex sections having a cross section of an angled profile, and including a flat part having a width P3 of 0.55 P or more which is formed between the opposite end parts of the angled profile located downward from the top of the angled profile by 3 μm.

The present invention also provides a coating apparatus for applying a coating solution to a continuously running support medium via a coating rod, the coating rod being a cylindrical body having an outer surface in which convex sections having a width P1 and concave sections having a width P2 are alternately formed in an axial direction of the surface, so that a series of convex and concave sections having a constant pitch P=P1+P2 are formed, and each of the convex sections having a cross section of an angled profile, and including a flat part having a width P3 which is formed between the opposite end parts of the angled profile located downward from the top of the angled profile by 3 μm and a flat part having a width P4 which is formed between the opposite end parts of the angled profile located downward from the top of the angled profile by d/10, where d is a level difference between the top of the convex sections and the bottom of the concave sections, with the smaller one of P3 and P4 being 0.55 P or more.

The applicant of the present invention, after examining various studies, found that a coating rod having a series of convex and concave sections having a constant pitch P, in which each of the convex sections has a cross section of an angled profile and includes a flat part having a width P3 of 0.55 P or more which is formed between the opposite end parts of the angled profile located downward from the top of the angled profile by 3 μm, makes it possible to prevent lines having a constant pitch from being formed in applying a coating solution at a high speed.

The applicant of the present invention also found that a coating rod having a series of convex and concave sections having a constant pitch P, in which each of the convex sections has a cross section of an angled profile and includes a flat part having a width P4 that is formed between the opposite end parts of the angled profile located downward from the top of the angled profile by d/10, where d is a level difference between the top of the convex sections and the bottom of the concave sections, with the smaller one of P3 and P4 being 0.55 P or more, makes it possible to prevent lines having a constant pitch from being formed in applying a coating solution at a high speed, which will be described in detail below by way of Examples.

In the present invention, each of the convex sections of a coating rod includes a flat part which preferably has an arithmetical mean roughness (Ra) of 0.8 μm or less. Such a flat part of the convex section having an arithmetical mean roughness (Ra) of a predetermined value or less as defined by JIS B 0601 to form a smooth surface further provides effects in preventing lines having a constant pitch from being formed.

As described above, according to the present invention, a coating apparatus which does not form lines having a constant pitch in applying a coating solution at a high speed can be provided.

### BRIEF DESCRIPTION OF THE DRAWINGS

FIG. 1 is a configuration view illustrating a coating line to which a coating apparatus according to the present invention is applied;

FIGS. 2A and 2B are partially enlarged cross sectional views showing a roller which is used in a coating apparatus according to the present invention;

FIG. 3 is a configuration view illustrating a coating line to which another coating apparatus according to the present invention is applied;

FIG. 4 is a table showing conditions and results of Examples 1 to 3 and Comparative Examples 1 to 3;

FIG. 5 is an enlarged cross sectional view showing a roller used in Example 1;

FIG. 6 is an enlarged cross sectional view showing a roller used in Comparative Examples 1 and 4;

FIG. 7 is an enlarged cross sectional view showing a roller used in Examples 2 and 5;

FIG. 8 is an enlarged cross sectional view showing a roller used in Comparative Example 2A;

FIG. 9 is an enlarged cross sectional view showing a roller used in Comparative Examples 2B and 5;

FIG. 10 is an enlarged cross sectional view showing a roller used in Example 3;

FIG. 11 is an enlarged cross sectional view showing a roller used in Comparative Example 3;

FIG. 12 is a table showing conditions and results of Examples 4 and 5 and Comparative Examples 4 and 5; and

FIG. 13 is an enlarged cross sectional view showing a roller used in Example 4.

### DESCRIPTION OF SYMBOLS

10, 10′ coating line,

12 roll coater

12A, 12B, and 12C roller

15 bar coater

16 web

112 bar for coating a solution

P pitch

P1 width of convex section

P2 width of concave section

P3, P4 width of flat part

### BEST MODE FOR CARRYING OUT THE INVENTION

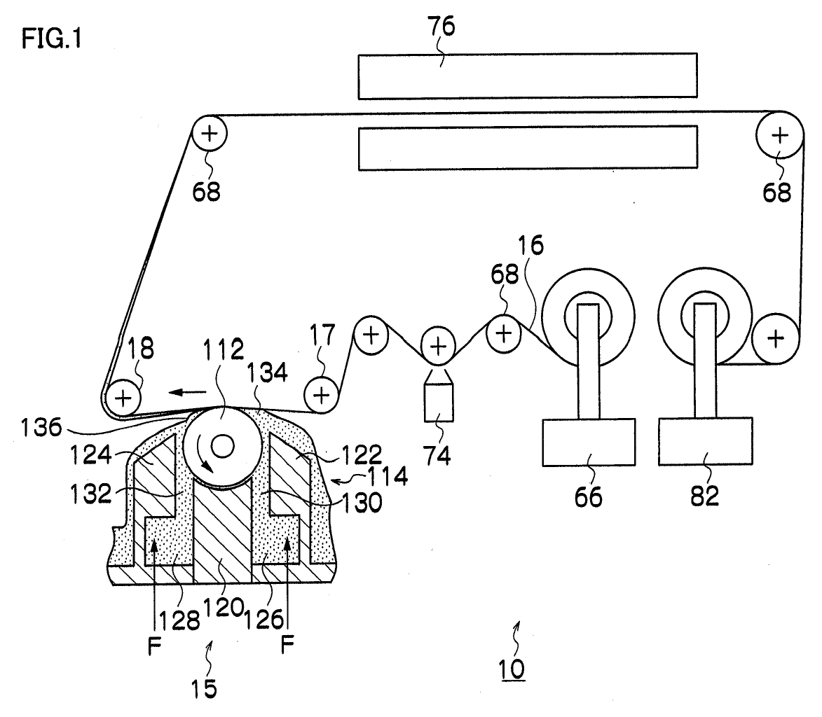

Now, a preferred embodiment (a first embodiment) of a coating apparatus of the present invention will be explained in detail below with reference to the accompanying drawings. FIG. 1 is a configuration view illustrating a coating line 10 to which a coating apparatus according to the present invention is applied.

The coating line 10 includes, as shown in FIG. 1, a feeding apparatus 66 which is configured to feed a web 16 that is a strip-shaped flexible support medium. The web 16 is guided by a guide roller 68 to be fed into a dust collector 74. The dust collector 74 removes dust attached to surfaces of the web 16.

A bar coater 15 is provided downstream of the dust collector 74 so that a coating solution F is applied to the web 16. A zone for drying 76 is provided downstream of the bar coater 15 so that an applied film on the web 6 is processed to be dried. The web 16 having the dried film is wound by a winder 82 which is provided downstream of the zone for drying 76.

As shown in FIG. 1 as a cross sectional view, the bar coater (bar coating apparatus) 15 includes a coating head 114 having a coating bar 112 for applying a coating solution to the running web 16 which is guided by guide rollers such as an upstream guide roller 17. The guide rollers such as an upstream guide roller 17 are arranged to allow the web 16 run close to the coating bar 112.

The coating head 114 generally includes the coating bar 112, a backup member 120, coater blocks 122 and 124, and the coating bar 112 is rotatably supported by the backup member 120. There are formed manifolds 126, 128 and slots 130, 132 between the backup member 120 and each of the coater blocks 122 and 124 respectively, so that the coating solution F is supplied to each of the manifolds 126 and 128.

The coating solution F supplied to each of the manifolds 126 and 128 is uniformly extruded in a width direction of the web through the narrow slots 130 and 132. This allows an upstream coating bead 134 to be formed upstream of the coating bar 112 in the feeding direction of the web 16, and allows a downstream coating bead 136 to be formed downstream of the coating bar 112. Via the coating beads 134 and 136, the coating solution F is applied to the running web 16.

An excess amount of the coating solution F supplied from the manifolds 126 and 128 overflows into the space between each of the coater blocks 122 and 124 and the web 16, and is collected via side grooves (not shown). The coating solution F may be supplied to the manifolds 126 and 128 at the center part of the manifolds 126 and 128 or the end parts of manifolds 126 and 128.

Next, a surface profile of the coating bar 112 that faces toward the web 16 will be explained below, which is a feature of the present invention.

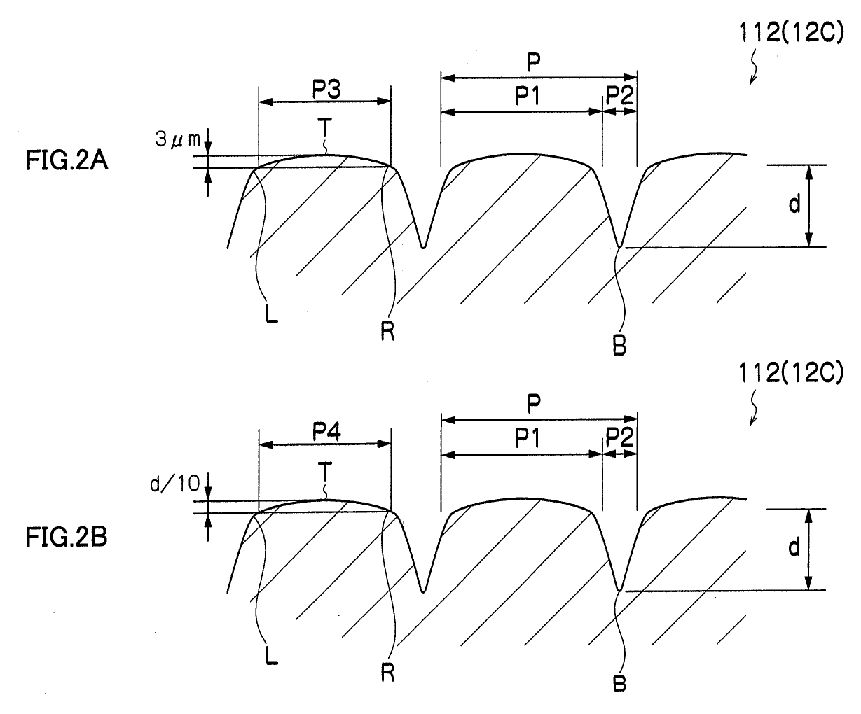

FIGS. 2A and 2B are partially enlarged cross sectional views of the coating bar 112, and show a part of a surface structure of the coating bar 112. As shown in FIGS. 2A and 2B, the coating bar 112 includes convex sections having a width P1 and concave sections having a width P2 which are alternately formed in an axial direction of the surface, so that a series of convex and concave sections having a constant pitch P=P1+P2 are formed. In the present invention, the position of a boundary between a convex section and a concave section is not so important.

In the present invention, as shown in FIG. 2A, a structure of each of the convex sections is important, that is, the convex section has a cross section of an angled profile and includes a flat part having a width P3 of 0.55 P or more which is formed between the opposite end parts of the angled profile located downward from the top of the angled profile by 3 μm.

As described above, the applicant of the present invention, after examining various studies, found that each of the convex sections including a flat part having a width P3 of 0.55 P or more makes it possible to prevent lines having a constant pitch from being formed in applying a coating solution at a high speed, which will be described in detail below by way of Examples.

The flat part having the width P3 will be explained with reference to FIGS. 2A and 2B, the P3 being a distance between a left end part L which is located on one end of the angled profile downward from the top T of the angled profile by 3 μm and a right end part R which is located on the other end of the angled profile downward from the top T of the angled profile by 3 μm.

The angled profile may have a cross section of any shape including, without limitation, a shape of an arc having a radius of single curvature, a shape of connected arcs having radii of curvatures, a parabolic shape, an elliptical shape, a hyperbolic shape, and the like.

In the present invention, the structure of each of the convex sections is important, that is, as shown in FIG. 2B, each of the convex sections has a cross section of an angled profile and includes a flat part having a width P4 of 0.55 P or more that is formed between the opposite end parts of the angled profile located downward from the top of the angled profile by d/10, where d is a level difference between the top of the convex sections and the bottom of a concave section.

The flat part having the width P3 or the width P4 may have a small groove having a depth of 5 μm or less, which is also included in the scope of the present invention.

The flat part of a convex section preferably has an arithmetical mean roughness (Ra) of 0.8 μm or less. Such a flat part of a convex section having an arithmetical mean roughness (Ra) of a predetermined value or less as defined by JIS B 0601 to form a smooth surface further provides effects in preventing lines having a constant pitch from being formed. The arithmetical mean roughness (Ra) of the flat part is preferably 1.5 m or less, and more preferably 0.8 μm or less.

The coating bar 112 of the bar coater 15 may have an outer diameter of any size, without limitation, of 5 to 20 mm, for example.

The coating bar 112 of the bar coater 15 may be formed of any material including, without limitation, steel with hard chrome plating, and steel with ceramic coating, for example.

The convex and concave sections of the coating bar 112 may be formed by any method including, without limitation, various processings such as cutting processing, rolling processing, and laser machining processing.

When the web 16 used in the present invention is formed of a metal material, the material may be aluminum or alloys thereof (for example, alloys including silicon, copper, manganese, magnesium, chromium, zinc, lead, bismuth, or nickel), iron, and iron alloys which are dimensionally stable. Usually, well known materials in the prior art which are described in Aluminum Handbook, 4^{th} Edition, Japan Light Metal Association, 1990, such as JIS A 1050, JIS A 1100, JIS A 3103, JIS A 3004, JIS A 3005, or alloys thereof which are added with magnesium to 0.1% by weight or more to increase tensile strength may be used.

When the web 16 used in the present invention is formed of a resin material, known materials such as polyethylene, polypropylene, poly(vinyl chloride), polyvinylidene chloride, poly vinyl acetate, polystyrene, polycarbonate, polyamide, PET (polyethylene terephthalate), biaxially stretched polyethylene terephthalate, polyethylene naphthalate, polyamide imide, polyimide, aromatic polyamide, cellulose triacetate, cellulose acetate propionate, and cellulose diacetate may be used. Among these materials, in particular, polyethylene terephthalate, polyethylene naphthalate, and polyamide are preferable.

The web 16 having a width of 0.1 to 3 m, a length of 1000 to 100000 m, and a thickness of 0.1 to 0.5 mm for a metal material or a thickness of 0.01 to 0.3 mm for a resin material is generally used. However, the web 16 having other sizes may be used.

Next, a formation of a coating film onto the web 16 by using the coating line shown in FIG. 1 will be explained below. First, the feeding apparatus 66 feeds the web 16 which has a thickness of 0.05 to 0.3 mm for example. The web 16 is guided by the guide roller 68 into the dust collector 74, so that dust attached to the web 16 is removed. Then the bar coater 15 applies the coating solution F to the web 16.

In coating even at a high speed, as described above, the coating bar 112 of the bar coater 15 is able to prevent lines having a constant pitch from being formed.

After the coating, the web 16 passes through the zone for drying 76 to form a coating layer. The web 16 having the coating layer is wound up by the winder 82.

Although an embodiment of a coating apparatus according to the present invention has been described above, the present invention is not limited to the above embodiment, and various aspects may be realized in different embodiments.

For example, the bar coater 15 is used as a coating apparatus in the above embodiment, but a coating apparatus having other cylindrical body (coating roller) may be used. Now, as such an example, a roll coater (second embodiment) will be explained below.

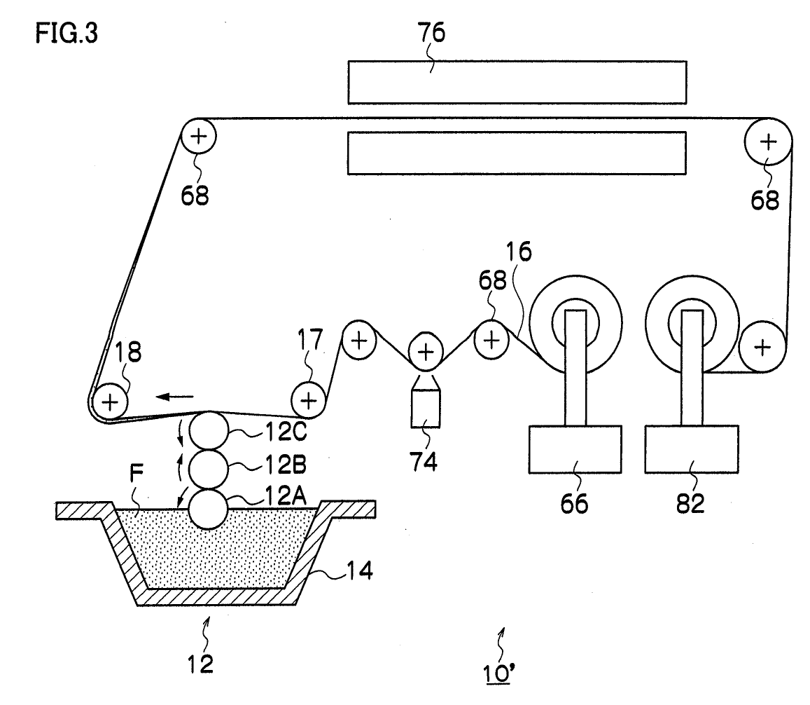

FIG. 3 is a configuration view illustrating a coating line 10′ to which a roll coater 12 is applied as a coating apparatus according to the present invention. The same or similar members as those in the above described coating line 10 of FIG. 1 are designated by like reference numerals, and will not be explained in detail below.

The roll coater 12 applies a coating solution to the running web 16 which is guided by guide members including the upstream guide roller 17 and the downstream guide roller 18 by using three rollers 12A, 12B, and 12C which are in contact with each other in a vertical direction and are driven to individually rotate in directions shown by arrows of FIG. 3. The upstream guide roller 17 and the downstream guide roller 18 are arranged so that the web 16 runs under a predetermined pressure which is applied by the roller 12C.

The upstream guide roller 17 and the downstream guide roller 18 may be a hollow pipe formed of iron having chrome plating, a hollow pipe formed of aluminum having hard plating, a hollow pipe formed of only aluminum, and the like.

The upstream guide roller 17 and the downstream guide roller 18 are supported in parallel with the roller 12C of the roll coater 12. Preferably, the upstream guide roller 17 and the downstream guide roller 18 are also rotatably supported by bearing members (ball bearings or the like) at both end parts thereof, and do not include any driving mechanism.

The rollers 12A, 12B, and 12C of the roll coater 12, the upstream guide roller 17, and the downstream guide roller 18 have generally the same length as the width of the web 16.

The rollers 12A, 12B, and 12C of the roll coater 12 are driven to rotate as shown by the arrows of FIG. 3. The roller 12C is set to rotate in the direction to which the web 16 is running, and to rotate at the same peripheral speed as that of the running speed of the web 16. Alternatively, depending on a coating condition, a coating that is achieved by driving the roller in the opposite direction to that of FIG. 3, or a coating that is achieved without driving the roller to rotate may be possible. Also, one of the rollers 12A, 12B, and 12C of the roll coater 12 may be provided with a doctor blade to scrape off an excess of a coating solution.

In the embodiment, the roll coater 12 is driven by a direct driving method which uses an inverter motor (with a shaft being directly coupled), but may be driven by a method which uses a combination of various motors and a reducer (gear head), or a method which uses a device for transmitting power of various motors for entrainment, such as a timing belt.

Among the rollers 12A, 12B, and 12C of the roll coater 12, the roller 12C has a surface which mates with the web 16, which will be explained below.

A solution pan 14 is provided below the roller 12A of the roll coater 12, and the solution pan 14 is filled with the coating solution F. The substantially lower part of the roller 12A is immersed in the coating solution F. This configuration allows the coating solution to be supplied to the surfaces of each of the rollers 12A, 12B, and 12C of the roll coater 12.

The surface of the roller 12C is, as shown in FIGS. 2A and 2B, provided with a series of convex and concave sections having a constant pitch P=P1+P2, and each of the convex sections has a cross section of an angled profile, and includes a flat part having a width P3 of 0.55 P or more which is formed between the opposite end parts of the angled profile located downward from the top of the angled profile by 3 μm.

The surface of the roller 12C may include, as described above, a convex section which has a cross section of an angled profile and includes a flat part having a width P4 of 0.55 P or more that is formed between the opposite end parts of the angled profile located downward from the top of the angled profile by d/10, where d is a level difference between the top of the convex section and the bottom of a concave section.

The roller 12C may have an outer diameter of any size, without limitation, of 100 to 200 mm, for example.

The above described configuration allows the coating solution F of a measured predetermined amount to be applied to the web 16 to be coated, and in the coating at a high speed, the roller 12C of the roll coaster 12 prevents lines having a constant pitch from being formed.

### EXAMPLES

Next, Examples and Comparative Examples which use a coating apparatus of the present invention will be explained below, but the present invention is not limited to the Examples.

In the following Examples 1 to 3 and Comparative Examples 1 to 3, the coating solution F was coated to the web 16 using the coating line 10 shown in FIG. 1. The coating bar 112 (see FIG. 1) had an outer diameter of 18 mm in each of these Examples and Comparative Examples.

The used coating solution F was a mixture including acrylic acid copolymer of 5 parts by weight, ethylene glycol monomethylether of 58 parts by weight, and methanol of 30 parts by weight. The coating solution F had a viscosity of 8 mPas (8 cp), and a surface tension of 0.28 mN/cm (28 dyn/cm).

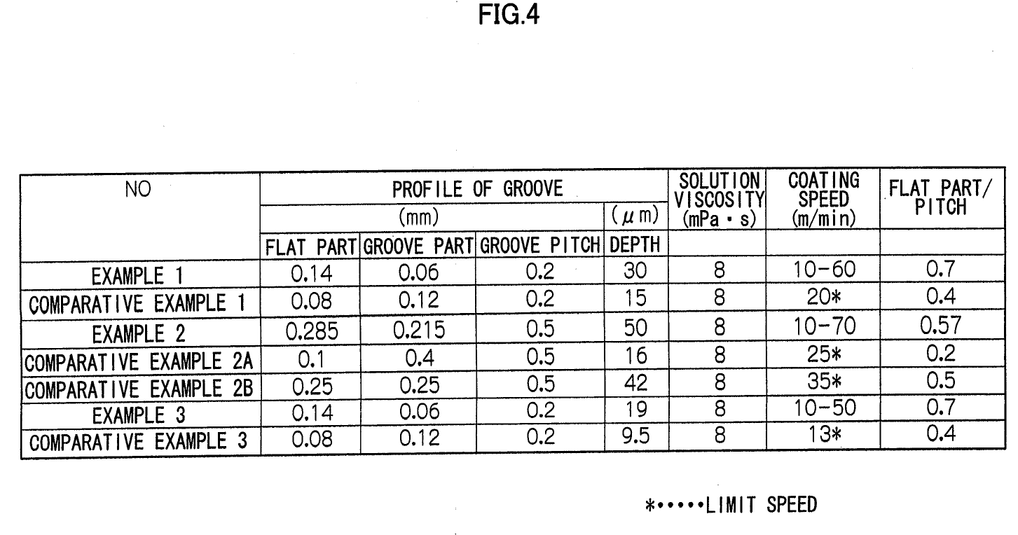

The web 16 was formed of aluminum having a thickness of 0.2 mm and a width of 1000 mm. The running speed of the web 16 was changed from 10 to 50 m/min, from 10 to 60 m/min, or from 10 to 70 m/min. The conditions and results of Examples 1 to 3 and Comparative Examples 1 to 3 are shown in the table of FIG. 4.

### Example 1

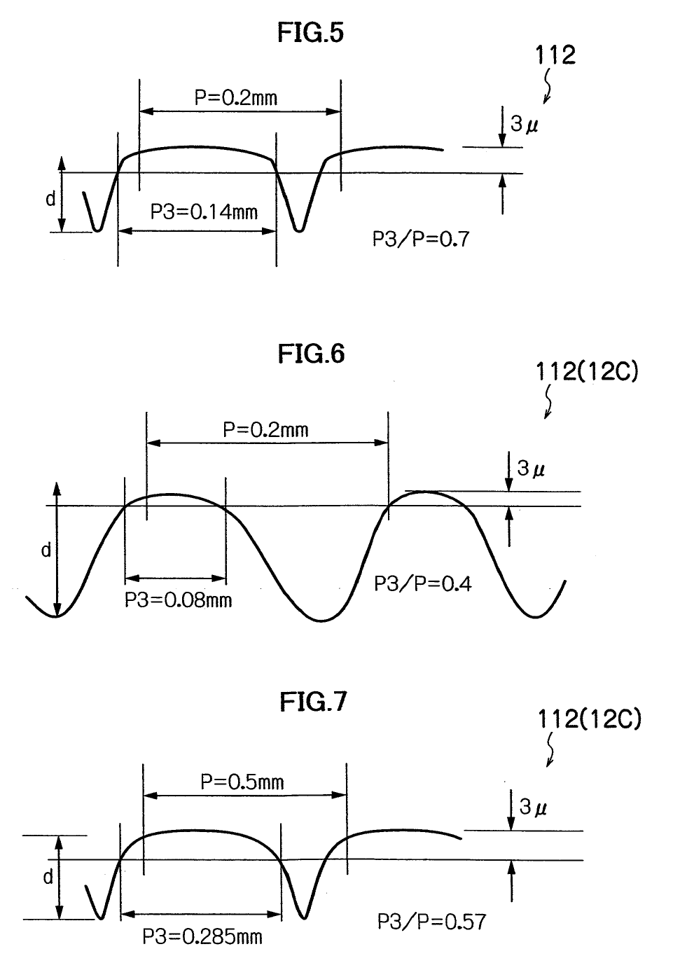

The coating line 10 shown in FIG. 1 was used, and the coating bar 112 (see FIG. 1) shown in the enlarged cross sectional view of FIG. 5 was used. The coating bar 112 had a series of convex and concave sections having a pitch P of 0.2 mm, and each of the convex sections had a flat part which was formed between the opposite end parts of the angled profile located downward from the top of the angled profile by 3 μm and had a width P3 of 0.14 mm. This means that the width P3 was 0.7 P which satisfies the requirement of the value of 0.55 P or more.

Each of the concave sections was formed to have a groove depth d of 30 μm. And the flat part had an arithmetical mean roughness (Ra) of 0.5 μm.

The coating bar 112 was rotated in the same direction as the direction in which the web 16 was running and at the same speed as the running speed of the web 16, to apply the coating solution F to be coated. The running speed of the web 16 was changed from 10 to 60 m/min. After being dried, the surface of the web 16 was examined to find no lines having a constant pitch formed thereon.

### Comparative Example 1

The coating line 10 shown in FIG. 1 was used, and the coating bar 112 (see FIG. 1) shown in the enlarged cross sectional view of FIG. 6 was used. The coating bar 112 had a series of convex and concave sections having a pitch P of 0.2 mm, and each of the convex sections had a flat part which was formed between the opposite end parts of the angled profile located downward from the top of the angled profile by 3 μm and had a width P3 of 0.08 mm. This means that the width P3 was 0.4 P which does not satisfy the requirement of the value of 0.55 P or more.

Each of the concave sections was formed to have a groove depth d of 15 μm. And the flat part had an arithmetical mean roughness (Ra) of 0.5 μm (the same setting as that of Example 1).

The coating bar 112 was rotated in the same direction as the direction in which the web 16 was running and at the same speed as the running speed of the web 16, to apply the coating solution F to be coated. The running speed of the web 16 was changed from 10 to 20 m/min when lines having a constant pitch were formed on the surface of the web 16.

### Example 2

The coating line 10 shown in FIG. 1 was used, and the coating bar 112 (see FIG. 1) shown in the enlarged cross sectional view of FIG. 7 was used. The coating bar 112 had a series of convex and concave sections having a pitch P of 0.5 mm, and each of the convex sections had a flat part which was formed between the opposite end parts of the angled profile located downward from the top of the angled profile by 3 μm and had a width P3 of 0.28-5 mm. This means that the width P3 was 0.57 P which satisfies the requirement of the value of 0.55 P or more.

Each of the concave sections was formed to have a groove depth d of 50 μm. And the flat part had an arithmetical mean roughness (Ra) of 0.5 μm.

The coating bar 112 was rotated in the same direction as the direction in which the web 16 was running and at the same speed as the running speed of the web 16, to apply the coating solution F to be coated. The running speed of the web 16 was changed from 10 to 70 m/min. After being dried, the surface of the web 16 was examined to find no lines having a constant pitch formed thereon.

### Comparative Example 2A

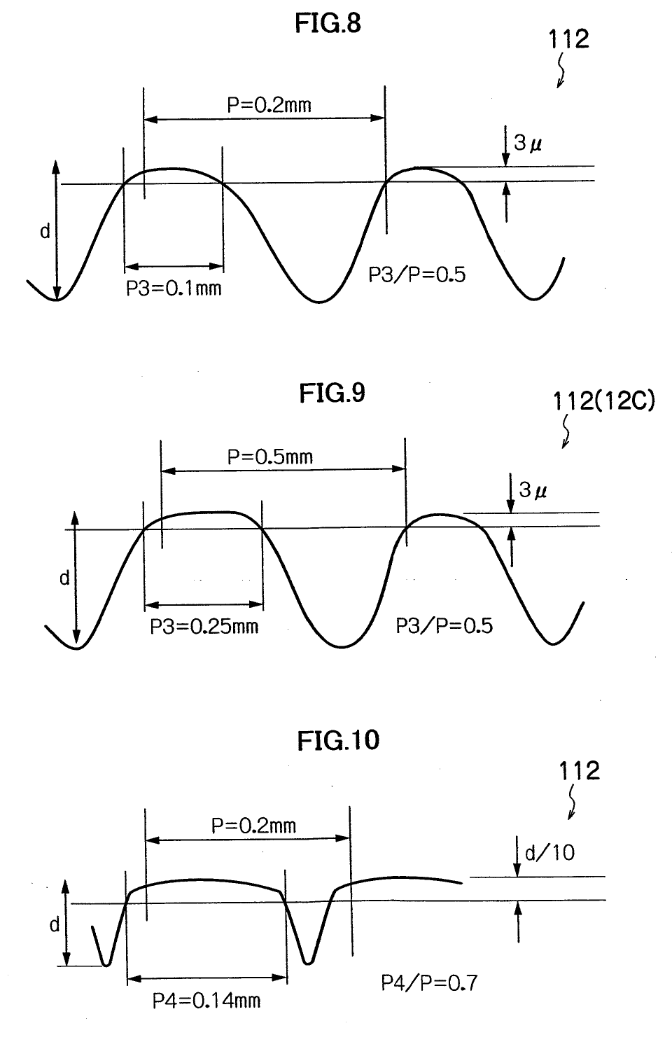

The coating line 10 shown in FIG. 1 was used, and the coating bar 112 (see FIG. 1) shown in the enlarged cross sectional view of FIG. 8 was used. The coating bar 112 had a series of convex and concave sections having a pitch P of 0.5 mm, and each of the convex sections had a flat part which was formed between the opposite end parts of the angled profile located downward from the top of the angled profile by 3 μm and had a width P3 of 0.1 mm. This means that the width P3 was 0.2 P which does not satisfy the requirement of the value of 0.55 P or more.

Each of the concave sections was formed to have a groove depth d of 16 μm. And the flat part had an arithmetical mean roughness (Ra) of 0.5 μm (the same setting as that of Example 2).

The coating bar 112 was rotated in the same direction as the direction in which the web 16 was running and at the same speed as the running speed of the web 16, to apply the coating solution F to be coated. The running speed of the web 16 was changed from 10 to 25 m/min when lines having a constant pitch were formed on the surface of the web 16.

### Comparative Example 2B

The coating line 10 shown in FIG. 1 was used, and the coating bar 112 (see FIG. 1) shown in the enlarged cross sectional view of FIG. 9 was used. The coating bar 112 had a series of convex and concave sections having a pitch P of 0.5 mm, and each of the convex sections had a flat part which was formed between the opposite end parts of the angled profile located downward from the top of the angled profile by 3 μm and had a width P3 of 0.25 mm. This means that the width P3 was 0.5 P which does not satisfy the requirement of the value of 0.55 P or more.

Each of the concave sections was formed to have a groove depth d of 42 μm. And the flat part had an arithmetical mean roughness (Ra) of 0.5 μm (the same setting as that of Example 2).

The coating bar 112 was rotated in the same direction as the direction in which the web 16 was running and at the same speed as the running speed of the web 16, to apply the coating solution F to be coated. The running speed of the web 16 was changed from 10 to 35 m/min when lines having a constant pitch were formed on the surface of the web 16.

### Example 3

The coating line 10 shown in FIG. 1 was used, and the coating bar 112 (see FIG. 1) shown in the enlarged cross sectional view of FIG. 10 was used. The coating bar 112 had a series of convex and concave sections having a pitch P of 0.2 mm, and each of the convex sections had a flat part which is formed between the opposite end parts of the angled profile located downward from the top of the angled profile by d/10 and had a width P4 of 0.14 mm. This means that the width P4 was 0.7 P which satisfies the requirement of the value of 0.55 P or more.

Each of the concave sections was formed to have a groove depth d of 19 μm. And the flat part had an arithmetical mean roughness (Ra) of 0.5 μm.

The coating bar 112 was rotated in the same direction as the direction in which the web 16 was running and at the same speed as the running speed of the web 16, to apply the coating solution F to be coated. The running speed of the web 16 was changed from 10 to 50 m/min. After being dried, the surface of the web 16 was examined to find no lines having a constant pitch formed thereon.

### Comparative Example 3

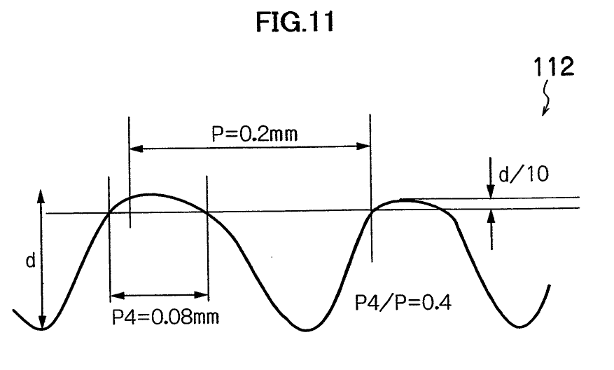

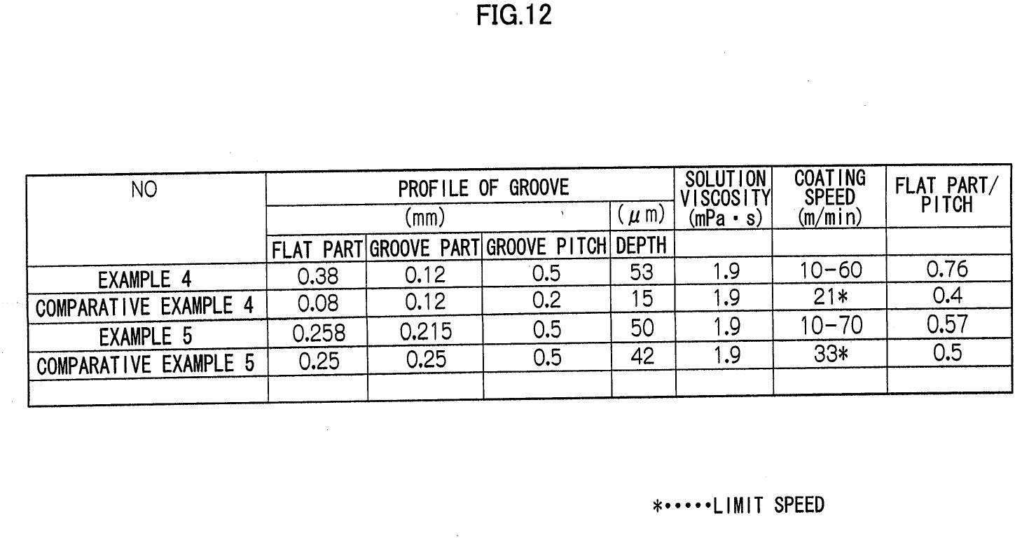

The coating line 10 shown in FIG. 1 was used, and the coating bar 112 (see FIG. 1) shown in the enlarged cross sectional view of FIG. 11 was used. The coating bar 112 had a series of convex and concave sections having a pitch P of 0.2 mm, and each of the convex sections had a flat part which was formed between the opposite end parts of the angled profile located downward from the top of the angled profile by d/10 and had a width P4 of 0.08 mm. This means that the width P4 was 0.4 P which does not satisfy the requirement of the value of 0.55 P or more.

Each of the concave sections was formed to have a groove depth d of 9.5 μm. And the flat part had an arithmetical mean roughness (Ra) of 0.5 μm (the same setting as that of Example 3).

The coating bar 112 was rotated in the same direction as the direction in which the web 16 was running and at the same speed as the running speed of the web 16, to apply the coating solution F to be coated. The running speed of the web 16 was changed from 10 to 13 m/min when lines having a constant pitch were formed on the surface of the web 16.

In the following Examples 4 and 5 and Comparative Examples 4 and 5, the coating solution F was coated to the web 16 using the coating line 10′ shown in FIG. 3. The roller 12C (see FIG. 3) had an outer diameter of 150 mm in each of these Examples and Comparative Examples.

The used coating solution F was a mixture including acrylic acid copolymer of 5 parts by weight, ethylene glycol monomethylether of 296 parts by weight, and methanol of 153 parts by weight. The coating solution F had a viscosity of 1.9 mPas (1.9 cp), and a surface tension of 0.28 mN/cm (28 dyn/cm).

The web 16 was formed of aluminum having a thickness of 0.2 mm and a width of 1000 mm. The running speed of the web 16 was changed from 10 to 60 m/min, or from 10 to 70 m/min. The conditions and results of Examples 4 and 5 and Comparative Examples 4 and 5 are shown in the table of FIG. 12.

### Example 4

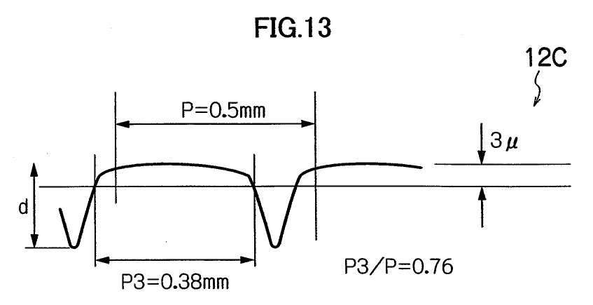

The coating line 10′ shown in FIG. 3 was used, and the roller 12C (see FIG. 3) shown in the enlarged cross sectional view of FIG. 13 was used. The roller 12C had a series of convex and concave sections having a pitch P of 0.5 mm, and each of the convex sections had a flat part which was formed between the opposite end parts of the angled profile located downward from the top of the angled profile by 3 μm and had a width P3 of 0.38 mm. This means that the width P3 was 0.76 P which satisfies the requirement of the value of 0.55 P or more.

Instead of the roll coater 12 of FIG. 3, a roll coater having two rolls, that is, the roller 12B and the roller 12C, was used.

Each of the concave sections was formed to have a groove depth d of 53 μm. And the flat part had an arithmetical mean roughness (Ra) of 0.5 μm.

The roller 12C was rotated in the same direction as the direction in which the web 16 was running and at the same speed as the running speed of the web 16, to apply the coating solution F to be coated. The running speed of the web 16 was changed from 10 to 60 m/min. After being dried, the surface of the web 16 was examined to find no lines having a constant pitch formed thereon.

### Comparative Example 4

The coating line 10′ shown in FIG. 3 was used, and the roller 12C (see FIG. 3) shown in the enlarged cross sectional view of FIG. 6 was used. The roller 12C had a series of convex and concave sections having a pitch P of 0.2 mm, and each of the convex sections had a flat part which was formed between the opposite end parts of the angled profile located downward from the top of the angled profile by 3 μm and had a width P3 of 0.08 mm. This means that the width P3 was 0.4 P which does not satisfy the requirement of the value of 0.55 P or more.

Instead of the roll coater 12 of FIG. 3, a roll coater having two rolls, that is, the roller 12B and the roller 12C, was used.

Each of the concave sections was formed to have a groove depth d of 15 μm. And the flat part had an arithmetical mean roughness (Ra) of 0.5 μm (the same setting as that of Example 4).

The roller 12C was rotated in the same direction as the direction in which the web 16 was running and at the same speed as the running speed of the web 16, to apply the coating solution F to be coated. The running speed of the web 16 was changed from 10 to 21 m/min when lines having a constant pitch were formed on the surface of the web 16.

### Example 5

The coating line 10′ shown in FIG. 3 was used, and the roller 12C (see FIG. 3) shown in the enlarged cross sectional view of FIG. 7 was used. The roller 12C had a series of convex and concave sections having a pitch P of 0.5 mm, and each of the convex sections had a flat part which was formed between the opposite end parts of the angled profile located downward from the top of the angled profile by 3 μm and had a width P3 of 0.285 mm. This means that the width P3 was 0.57 P which satisfies the requirement of the value of 0.55 P or more.

Instead of the roll coater 12 of FIG. 3, a roll coater having two rolls, that is, the roller 12B and the roller 12C, was used.

Each of the concave sections was formed to have a groove depth d of 50 μm. And the flat part had an arithmetical mean roughness (Ra) of 0.5 μm.

The roller 12C was rotated in the same direction as the direction in which the web 16 was running and at the same speed as the running speed of the web 16, to apply the coating solution F to be coated. The running speed of the web 16 was changed from 10 to 70 m/min. After being dried, the surface of the web 16 was examined to find no lines having a constant pitch formed thereon.

### Comparative Example 5

The coating line 10′ shown in FIG. 3 was used, and the roller 12C (see FIG. 3) shown in the enlarged cross sectional view of FIG. 9 was used. The roller 12C had a series of convex and concave sections having a pitch P of 0.5 mm, and each of the convex sections had a flat part which was formed between the opposite end parts of the angled profile located downward from the top of the angled profile by 3 μm and had a width P3 of 0.25 mm. This means that the width P3 was 0.5 P which does not satisfy the requirement of the value of 0.55 P or more.

Instead of the roll coater 12 of FIG. 3, a roll coater having two rolls, that is, the roller 12B and the roller 12C, was used.

Each of the concave sections was formed to have a groove depth d of 42 μm. And the flat part had an arithmetical mean roughness (Ra) of 0.5 μm (the same setting as that of Example 5).

The roller 12C was rotated in the same direction as the direction in which the web 16 was running and at the same speed as the running speed of the web 16, to apply the coating solution F to be coated. The running speed of the web 16 was changed from 10 to 33 m/min when lines having a constant pitch were formed on the surface of the web 16.

1. A coating apparatus for applying a coating solution to a continuously running support medium via a coating rod, the coating rod being a cylindrical body having an outer surface in which a convex section having a width PI and a concave section having a width P2 are alternately formed in an axial direction of the surface, so that a series of convex and concave sections having a constant pitch P=P1+P2 are formed, and each of the convex sections having a cross section of an angled profile and including a flat part having a width P3 of 0.55 P or more which is formed between the opposite end parts of the angled profile located downward from the top of the angled profile by 3 μm.

2. The coating apparatus according to claim 1, wherein each of the convex sections includes a flat part having a width P4 of 0.55 P or more which is formed between the opposite end parts of the angled profile located downward from the top of the angled profile by d/10, where d is a level difference between the top of the convex section and the bottom of the concave section.

3. A coating apparatus for applying a coating solution to a continuously running support medium via a coating rod,
the coating rod being a cylindrical body having an outer surface in which a convex section having a width P1 and a concave section having a width P2 are alternately formed in an axial direction of the surface, so that a series of convex and concave sections having a constant pitch P=P1+P2 are formed, and each of the convex sections having a cross section of an angled profile and including a flat part having a width P3 which is formed between the opposite end parts of the angled profile located downward from the top of the angled profile by 3 μm, and a flat part also having a width P4 which is formed between the opposite end parts of the angled profile located downward from the top of the angled profile by d/10, where d is a level difference between the top of the convex sections and the bottom of the concave sections, with the smaller one of P3 and P4 being 0.55 P or more.

4. The coating apparatus according to any one of claims 1 to 3 claim 1, wherein
the flat part of each convex section of the coating rod has an arithmetical mean roughness (Ra) of 0.8 μm or less.

5. The coating apparatus according to claim 2, wherein
the flat part of each convex section of the coating rod has an arithmetical mean roughness (Ra) of 0.8 m or less.

6. The coating apparatus according to claim 3, wherein
the flat part of each convex section of the coating rod has an arithmetical mean roughness (Ra) of 0.8 μm or less.
